(19) United States
(12) Patent Application Publication
(10) Pub. No.: US 2017/0253225 A1
(43) Pub. Date: Sep. 7, 2017

(54) BRAKE BOOSTER FOR A BRAKING SYSTEM OF A VEHICLE

(71) Applicant: Robert Bosch GmbH, Stutgart (DE)

(72) Inventor: Eduardo Herrera Lopez, South Lyon, MI (US)

(21) Appl. No.: 15/506,533

(22) PCT Filed: Jul. 31, 2015
(86) PCT No.: PCT/EP2015/067633

§ 371 Date: Feb. 24, 2017

(30) Foreign Application Priority Data
Sep. 1, 2014 (DE) 102014217433.3

(51) Int. Cl. B60T 13/565; B60T 13/569; B60T 13/575; B60T 13/57; B60T 13/74; B60T 7/04

(52) U.S. Cl. CPC B60T 13/565; B60T 13/746; B60T 7/04; B60T 13/575; B60T 13/57; B60T 13/569

(57) ABSTRACT

A brake booster for a braking system of a vehicle including: a valve body to which a booster force is transmittable, a reaction disk, and an output rod, situated on the reaction disk in such a way that the booster force is at least partially transmittable to the output rod via the reaction disk so that the output rod is displaceable in the braking direction, the output rod being pressable counter to the braking direction due to a counter force of a master brake cylinder of the braking system, and the valve body and/or the output rod being formed in such a way that a relative movement of the output rod, aligned counter to the braking direction with respect to the valve body, is limited by an impact of at least one first contact surface of the output rod on at least one second contact surface of the valve body.

### FIELD

The present invention relates to a brake booster for a braking system of a vehicle. Furthermore, the present invention relates to a braking system for a vehicle.

### BACKGROUND INFORMATION

FIGS. 1a and 1b show schematic representations of a conventional brake booster, as is described, for example, in German Patent Application No. DE 10 2010 038 918 A1.

The conventional brake booster 10, schematically represented in FIGS. 1a and 1b, has a valve body 12, a boost body 14, an input rod 16, an output rod 18, and a reaction disk 20. A central hole 22 is formed in valve body 12 through which input rod 16 extends at least partially.

Valve body 12 is situated on boost body 14 in such a way that valve body 12 is codisplaceable with the aid of boost body 14, which is displaced from its initial position along a first displacement path s1 in a braking direction. The displacement of boost body 14 from its initial position in the braking direction may be carried out, e.g., with the aid of an operation of a motor (not shown). In this way, a booster force F1, exerted on valve body 14 (e.g., by the motor), is at least partially transmittable to valve body 12 in such a way that valve body 12 presses against reaction disk 20.

A brake pedal 24 is linked to input rod 16 in such a way that a driver braking force F2, exerted on brake pedal 24, is at least partially transmittable to input rod 16 in such a way that input rod 16 is displaced from its initial position (counter to a spring force of a return spring 26) in the braking direction along a second displacement path s2 and presses against reaction disk 20. Both booster force F1 and driver braking force F2 are at least partially transmittable to output rod 18 via reaction disk 20. Output rod 18 is displaceable from its initial position in the braking direction with the aid of at least partially transmitted forces F1 and F2, whereby at least one displaceable piston of a master brake cylinder (not shown) situated on brake booster 10 is displaceable into at least one assigned pressure chamber of the master brake cylinder. However, the displacement inward of the at least one displaceable piston into its assigned pressure chamber counteracts a counter force F3 which presses output rod 18 against reaction disk 20.

FIG. 1 shows conventional brake booster 10 during an actuation of the brake pedal by the driver. The actuation of brake pedal 24 by the driver is supported in terms of force with the aid of an operation of the motor (not shown). Thus, FIG. 1a shows an operating situation of conventional brake booster 10 at a booster force F1 not equal to zero and a driver braking force F2 not equal to zero. First displacement path s1 and second displacement path s2 are also not equal to zero in the operating situation schematically represented in FIG. 1. At the same time, a counter force F3 not equal to zero is exerted on output rod 18.

The concerted effect of forces F1 through F3 on reaction disk 20 results in a deformation of reaction disk 20, whereby reaction disk 20 is pressed partially into central hole 22 up to a first penetration depth t1. A part of counter force F3 depicted with reference numeral F4 is thus supported on input rod 16 contacted by reaction disk 20.

FIG. 1b shows an operating situation of conventional brake booster 10 during an autonomous brake application. During the autonomous brake application, a brake pressure is built up in the master brake cylinder (not shown), without an actuation of brake pedal 24 by the driver, in that (e.g., with the aid of the operation of the motor) brake booster 12 is displaced in the braking direction. The displacement movement of brake booster 12 in the braking direction may cause the input rod 16 and brake pedal 24 to be dragged along.

However, in the operating situation of conventional brake booster 12, reproduced with the aid of FIG. 1b, only booster force F1 and counter force f3 are not equal to zero, while driver braking force F2 remains equal to zero. Thus, a support of reaction disk 20, deformed with the aid of forces F1 and F3, on input rod 16 is omitted. Reaction disk 20 is therefore partially pressed deeper into central hole 22 at a second penetration depth t2 (greater than first penetration depth t1).

### SUMMARY

The present invention provides a brake booster for a braking system of a vehicle and a braking system for a vehicle.

The present invention provides brake boosters which are useable for carrying out an autonomous brake application. “Autonomous brake application” may be understood to also include e.g., an autonomous brake pressure buildup, a power brake application, EBR brake application (external brake request), a brake application triggered solely by an on-vehicle automatic speed control, a brake application triggered with the aid of an external signal from a vehicle communication network, or a brake application due to an omitted actuation of a brake actuating element (brake pedal) by the driver. A brake booster according to the present invention may thus satisfy not only the standard functions of a convention brake booster, but may also be used to implement a braking system for autonomous brake application. Due to the multi-functionality of the brake booster according to the present invention, additional components may be omitted in a braking system equipped with the same.

At the same time, the present invention provides an improved protection/preservation of the reaction disk of the brake booster. In this way, a change/deterioration of the elastic properties of the reaction disk is reliably preventable even during a prolonged operation of the brake booster according to the present invention.

In one advantageous specific embodiment of the brake booster, the brake booster additionally includes an input rod which is able to be situated directly or indirectly on a brake actuating element of the braking system in such a way that a driver braking force exerted on the brake actuating element is at least partially transmittable to the input rod, and presses the input rod against the reaction disk in the braking direction with the aid of the at least partially transmitted driver braking force. In this case, it may be ensured with the aid of the present invention that even at with a prolonged operating time of the brake booster according to the present invention, a brake-actuating feel (pedal feel) of the driver changes little during actuation of the brake actuating element (brake pedal) interacting with the brake booster. The present invention thus also improves braking comfort for the driver of the vehicle equipped with the same. However, it is pointed out that the advantages described above are not limited to a brake booster type equipped with the input rod.

The reaction disk may be situated in a recess of the valve body. A reliable fit of the reaction disk is thus easily implementable.

For example, the valve body may include a flange surrounding the recess and extending perpendicular to the braking direction. The valve body is thus configurable with a comparatively large surface on the side aligned/alignable with the respective master brake cylinder of the braking system. Thus, a sufficient surface is provided for easy formation of the at least one second contact surface of the valve body, which is contactable with the aid of the output rod.

As an alternative or supplement to the configuration of the brake booster described in the preceding paragraph, the output rod may include an end section, aligned with the valve body, having a first diameter, aligned perpendicular to the braking direction, which is smaller than or equal to a recess diameter of the recess, which is aligned perpendicular to the braking direction, an intermediate section of the output rod adjoins the end section having a second diameter, aligned perpendicular to the braking direction, which is greater than the recess diameter aligned perpendicular to the braking direction. This type of shape of the output rod facilitates the configuration of the at least one first contact surface of the output rod, which is contactable with the aid of the at least one second contact surface of the valve body.

Advantageously, an extension of the end section extending along the braking direction is smaller than a height of the recess extending along the braking direction. In this case, a maximum deformation of the reaction disk is determinable with the aid of the extension of the end section.

In a preferred way, the at least one first contact surface of the output rod in its initial position is separated by a gap, having a predefined initial gap width, from the at least one second contact surface of the valve body in its initial position, the gap is able to be reduced to a gap width below the initial gap width with the aid of a displacement of the valve body in the braking direction. As is described more exactly below, a maximum deformation of the reaction disk (e.g., as a maximum penetration depth), may be reliably determined with the aid of the predefined initial gap width.

The brake booster may be, e.g., an electromechanical brake booster. However, it is pointed out that the configurability of the brake booster is not limited to a certain brake booster type.

The advantages described in the preceding paragraphs are also implemented for a braking system for a vehicle including a brake booster of this type and the master brake cylinder, on which the brake booster is directly or indirectly situated.

### BRIEF DESCRIPTION OF THE DRAWINGS

Additional features and advantages of the present invention are described below with reference to the figures.

FIGS. 1a and 1b show schematic representations of a conventional brake booster.

FIGS. 2a through 2c show schematic representations of one specific embodiment of the brake booster.

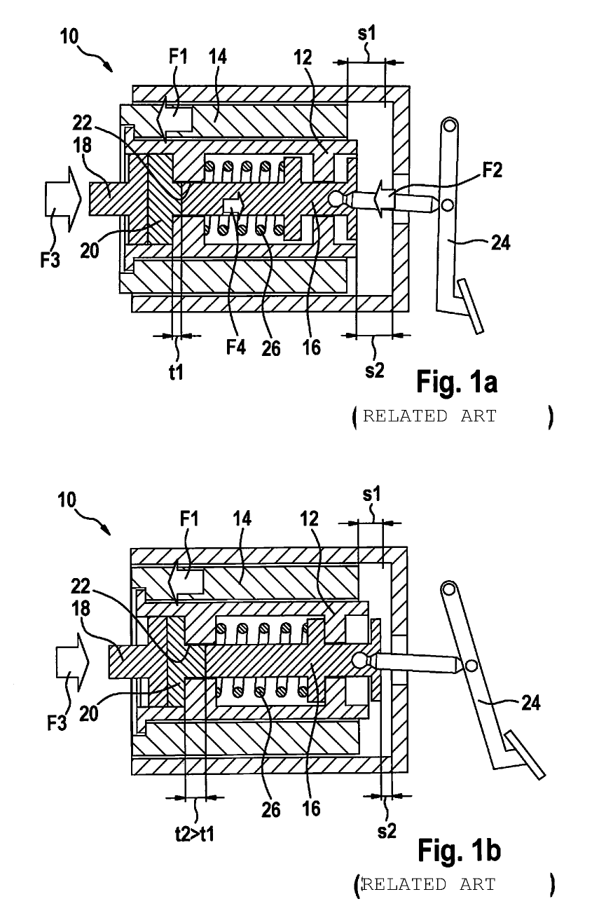

### DETAILED DESCRIPTION OF EXAMPLE EMBODIMENTS

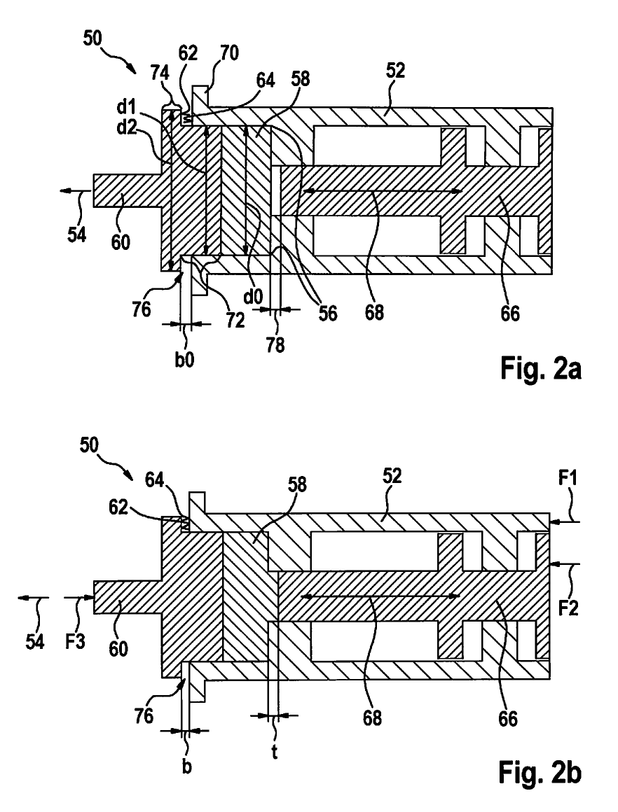

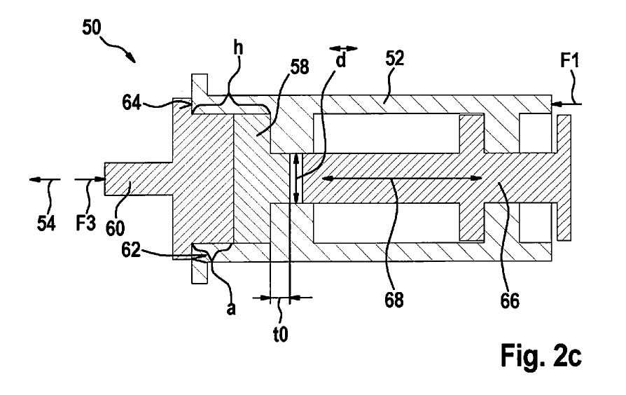

FIGS. 2a through 2c show schematic representations of one specific embodiment of the brake booster.

Brake booster 50, schematically depicted in FIGS. 2a through 2c, is usable in a braking system of a vehicle/motor vehicle. Brake booster 50 is able to be situated in particular (directly or indirectly) on a master brake cylinder (not shown) of the braking system of the vehicle/motor vehicle. It is pointed out that the usability of brake booster 50 is not limited to a certain braking system type or to a certain vehicle type/motor vehicle type. In addition, the usability of brake booster 50 is not limited to a certain type of master brake cylinder.

Brake booster 50 includes a valve body 52, on which a booster force F1 is transmittable in such a way that valve body 52 is displaceable (from its initial position) in a braking direction 54. In the specific embodiment of FIGS. 2a through 2c, brake booster 50 is designed as an electromechanical brake booster. In this case, valve body 52 is displaceable in braking direction 54 with the aid of booster force F1 from a motor (not shown). The motor applying booster force F1 may be a motor intrinsic to the brake booster or it may be a motor situated on brake booster 50 as an individual component. For example, valve body 52 may be connected to the motor via a boost body and/or via a screw thread. However, the configurability of brake booster 50 is not limited to an equipment/interaction with a certain motor type, a specific connection of valve body 52 to the respective motor, or to an electromechanically designed brake booster type.

Boost body 52 displaced (from its initial position) in braking direction 54 presses against a reaction disk 58. Reaction disk 58 may be situated, for example, in a recess 56 of boost body 52. In general, recess 56 is formed on a side of boost body 52 alignable/aligned with the master brake cylinder.

An output rod 60 of brake booster 50 is situated on reaction disk 58 in such a way that booster force F1 is at least partially transmittable to output rod 60 via reaction disk 58. With the aid of the at least partial transmission of booster force F1, output rod 60 is displaceable (from its initial position) in braking direction 54. Since brake booster 50 is able to be situated directly or indirectly on the master brake cylinder of the braking system, at least one displaceable piston of the master brake cylinder is at least partially displaceable, with the aid of output rod 60 displaced (from its initial position) in braking direction 54, into at least one assigned pressure chamber of the master brake cylinder. A counter force F3, counteracting an inward displacement of the at least one piston into the at least one assigned pressure chamber, is exertable on output rod 60, whereby output rod 60 is pressable counter to braking direction 54. (Counter force F3 may include, for example, a compressive force triggered due to an increase in brake pressure and a spring force of at least one return spring of the master brake cylinder.)

However, in the case of brake booster 50, valve body 52 and/or output rod 60 are formed in such a way that a relative movement of output rod 60 aligned counter to braking direction 54 with respect to valve body 52 is limited by an impact of at least one first contact surface/stop surface 62 of output rod 60 on at least one second contact surface/stop surface 64 of valve body 52. With the aid of the (direct) contact between at least one first contact surface 62 of output rod 60 and at least one second contact surface 64 of valve body 52 implementable in this way, output rod 60 may be supported (directly) on boost body 52. Thus, at least a part of counter force F3 exerted on output rod 60 may be (directly) transmitted to valve body 52 via the (direct) contact between at least one first contact surface 62 of output rod 60 and at least one second contact surface 64 of valve body 52. In this way, a remainder of counter force F3 exerted on reaction disk 58 is limitable (in particular to approximately zero).

As is described in greater detail below, with the aid of the (direct) contact between at least one first contact surface 62 of output rod 60 and at least one second contact surface 64 of valve body 52, a deformation of reaction disk 58 may also be limited. The advantageous design of brake booster 50 including the at least one first contact surface 62 of output rod 60 and the at least one second contact surface 64 of valve body 52 thus contributes to a protection of reaction disk 58 during an entire operating time/period of use of brake booster 50. Therefore, a change of the elastic properties of reaction disk 58 (due to a frequently undesirable strong deformation of reaction disk 58) need not be feared even during a long operating time/period of use of the brake booster.

Correspondingly, even after a long service life of brake booster 50, no impairment of an elasticity/functionality of reaction disk 58 need to be accepted. Even if brake booster 50 is equipped with a relatively inexpensive reaction disk 58, reaction disk 58 may reliably carry out its desired functionality for an increased operating time.

In the specific embodiment from FIGS. 2a through 2c, brake booster 50 additionally includes an input rod 66 which is able to be situated directly or indirectly on a brake actuating element (not shown) of the braking system in such a way that a driver braking force F2 exerted on the brake actuating element is at least partially transmittable to input rod 66. A brake pedal, for example, may be understood as a brake actuating element of the braking system. The applicability of brake booster 50 is, however, not limited to a braking system equipped with a brake pedal.

Input rod 66, displaced in braking direction 54 by at least partially transmitted driver braking force F2, also presses against reaction disk 58. However, due to the protection of reaction disk 58 described in the preceding paragraph, a constant reaction of reaction disk 58 to input rod 66 and thus to the brake actuating element linked thereto is ensured, even over a long operating time of brake booster 50. A driver actuating the brake actuating element thus also senses a standard reaction of reaction disk 58 to driver braking force F2, even after a prolonged use of the same reaction disk 58. The advantageous design of brake booster 50 thus also contributes to an increase in the operating comfort of the brake actuating element linked to brake booster 50.

In the exemplary embodiment from FIGS. 2a through 2c, input rod 66 extends partially through a central hole 68 in the interior of booster body 52 (with a hole diameter d̅). Central hole 68 extends up to recess 66 so that a (direct) contact between input rod 66 and reaction disk 58 is possible. The configuration of brake booster 50, schematically shown in FIGS. 2a through 2c, with input rod 66 extending centrally through valve body 52 is, however, to be interpreted merely as an example. In addition, the configurability of brake booster 50 is not limited to its being equipped with input rod 66.

In the specific embodiment from FIGS. 2a through 2c, valve body 52 has by way of example a flange 70, surrounding recess 66 and extending perpendicular to braking direction 54. In addition, output rod 60 has an end section 72 aligned with valve body 52 and an intermediate section 74 abutting end section 72. End section 72 of output rod 60 is designed with a first diameter d1, aligned perpendicular to braking direction 54, which is smaller than a recess diameter d0 of recess 66 extending perpendicular to braking direction 54. (The play is preferably minimal.) In contrast, a second diameter d2 of intermediate section 74, aligned perpendicular to braking direction 54, is greater than recess diameter d0 of recess 56, aligned perpendicular to braking direction 54. Thus, the at least first contact surface 62 is easily formable on intermediate section 74.

An extension a of end section 72, extending along braking direction 54, is preferably smaller than a height h of recess 56, extending along braking direction 54. (A distance between an opening of recess 56 and a surface of valve body 52 aligned/alignable with the master brake cylinder and contacted by reaction disk 58 may be understood as height h of recess 56.) As described below in greater detail, a maximum deformation of reaction disk 58 is determinable with the aid of extension a of end section 72.

FIG. 2a shows brake booster 50 in an inactive state. An operating situation of brake booster 50 during a non-actuation of the brake actuating element and in a non-activated operation of the respective motor may be understood to be this state. Since neither a booster force F1 is transmitted to valve body 52 nor a driver braking force F2 to input rod 66 in the operating situation shown in FIG. 2a, components 52, 60, 66 are in their initial positions (rest positions). Reaction disk 58 is in its initial form in this type of operating situation of brake booster 50. Preferably, at least one first contact surface 62 of output rod 60, in its initial position, is separated from at least one second contact surface 64 of valve body 52, in its initial position, by a gap 76 with a predefined initial gap width b0. An intermediate gap 78 may also separate input rod 66, in its initial position, from reaction disk 58.

FIG. 2b shows brake booster 50 during an actuation of the assigned brake actuating element by the driver (at a driver braking force F2 not equal to zero). The braking intention predefined by the driver in this way is increased with the aid of a displacement of valve body 52 in braking direction 54 by providing booster force F1 (not equal to zero). (Gap 76 is reduced to a gap width b below initial gap width b0 with the aid of the displacement of valve body 52 in braking direction 54.)

The displacement of output rod 60 with the aid of forces F1 and F2 jointly transmitted thereon triggers counter force F3, described above, which is exerted on output rod 60. The concerted effect of forces F1 through F3 on reaction disk 58 results in its deformation. Specifically, in the exemplary embodiment from FIGS. 2a through 2c, reaction disk 58 is compressed to a penetration depth t into central hole 68 and is then supported on input rod 66.

Brake booster 50 may also be used to carry out an autonomous brake application. FIG. 2c shows brake booster 50 during this type of autonomous brake application (at a driver braking force F2 equal to zero). To carry out the autonomous brake application, a booster force F1 (not equal to zero) is exerted on valve body (e.g., with the aid of the motor), whereby valve body 52 is displaced (from its initial position) in braking direction 54. The displacement movement of valve body 52 may cause the otherwise unpowered input rod 66 to be dragged along without closing intermediate gap 78.

Thus, in the operating situation of brake booster 50 depicted in FIG. 2c, only booster force F1 (not equal to zero) is transmitted to output rod 60 via reaction disk 58. The displacement of output rod 60 with the aid of booster force F1 (not equal to zero) transmitted thereto causes the compression of output rod 60 by counter force F3 against reaction disk 58 counter to braking direction 54. Since, however, input rod 66 in the operating situation of brake booster 50 depicted in FIG. 2c does not contact reaction disk 58, there is also no way to support reaction disk 58 on input rod 66. However, in the advantageous brake booster 50 from FIGS. 2a through 2c, the penetration of reaction disk 58 into central hole 68 is limited to a maximum penetration depth t0, with the aid of the (direct) contact between the at least one first contact surface 62 of output rod 60 and the at least one second contact surface 64 of valve body 52. Maximum penetration depth t0 of reaction disk 58 into central hole 68 corresponds to the following formula:

$$t 0 = \frac{d {0}^{2}}{{\overleftrightarrow{d}}^{2}} * b 0$$

At a penetration depth t of reaction disk 58 into central hole 68 equal to the predefined maximum penetration depth t0, the at least one first contact surface 62 of output rod 60 contacts the at least one second contact surface 62 of valve body 52. A further compression inward of reaction disk 58 into central hole 68 is prevented with the aid of the (direct) contact at contact surfaces 62 and 64. The deformation of reaction disk 58 is limitable in this way. In other words, extension a of end section 72 of output rod 60 delimits a maximum compressibility of reaction disk 58 within recess 56. In this way, the advantageous protection of reaction disk 58 is reliably implemented.

In particular, counter force F3 may be directly transmitted from output rod 60 to valve body 52 after the closing of gap 76 (preferably only after a closing of a jump-in). The direct transmission of counter force F3 from output rod 60 to valve body 52 does not trigger an additional mechanical stress in reaction disk 58. Using the formula indicated above, maximum penetration depth t0 of reaction disk 58 into central hole 68 may be easily established to a desired value.

Brake booster 50 from FIGS. 2a through 2c thus provides a mechanical limitation of the deformation forces exerted on reaction disk 58. In this way, a deformation of reaction disk 58 is also limitable. A mechanical stress occurring in reaction disk 58 is likewise limitable with the aid of the advantageous design of brake booster 50.

Even during a fast release of the brake actuating element (brake pedal), when input rod 66 is displaced faster than valve body 52 into its initial position, penetration depth t of reaction disk 58 into the central hole is limitable to the predefined maximum penetration depth t0 with the aid of the closing of gap 76. Thus, the advantageous design of brake booster 50 also ensures a good protection of reaction disk 58 even in this type of situation.

To form brake booster 50, only a modification of parts of components 52 and 60 is necessary. Break booster 50 thus additionally satisfies all functions of the related art and is easily manufacturable.

1-9. (canceled)

10. A brake booster for a braking system of a vehicle, comprising:
a valve body to which a booster force is transmittable in such a way that the valve body is displaceable in a braking direction;
a reaction disk against which the valve body, displaced in the braking direction, presses; and
an output rod situated on the reaction disk in such a way that the booster force is at least partially transmittable to the output rod via the reaction disk in such a way that the output rod is displaceable in the braking direction;
wherein the brake booster is configured to be situated directly or indirectly on a master brake cylinder of the braking system in such a way that, with the aid of the output rod displaced in the braking direction, at least one displaceable piston of the master brake cylinder is at least partially displaceable into at least one assigned pressure chamber of the master brake cylinder and a counter force, counteracting an inward displacement of the at least one piston into the at least one pressure chamber, being exertable on the output rod, whereby the output rod is pressable counter to the braking direction;
wherein at least one of the valve body and the output rod is formed in such a way that a relative movement of the output rod aligned counter to the braking direction with respect to the valve body is limited by an impact of at least one first contact surface of the output rod on at least one second contact surface of the valve body.

11. The brake booster as recited in claim 10, further comprising:
an input rod which is able to be situated directly or indirectly on a brake actuating element of the braking system in such a way that a driver braking force exerted on the brake actuating element is at least partially transmittable to the input rod and the input rod, displaced in the braking direction with the aid of the at least partially transmitted driver braking force, presses against the reaction disk.

12. The brake booster as recited in claim 10, wherein the reaction disk is situated in a recess of the valve body.

13. The brake booster as recited in claim 12, wherein the valve body includes a flange surrounding the recess and extending perpendicular to the braking direction.

14. The brake booster as recited in claim 13, wherein the output rod includes an end section, aligned with the valve body, having a first diameter which is aligned perpendicular to the braking direction and is smaller than or equal to a recess diameter of the recess, aligned perpendicular to the braking direction, and an intermediate section of the output rod, abutting the end section, having a second diameter which is aligned perpendicular to the braking direction and is greater than the recess diameter aligned perpendicular to the braking direction.

15. The brake booster as recited in claim 14, wherein an extension of the end section extending along the braking direction is less than a height of the recess extending along the braking direction.

16. The brake booster as recited in claim 10, wherein the at least one first contact surface of the output rod in its initial position is separated from the at least one second contact surface of the valve body in its initial position by a gap with a predefined initial gap width, and the gap being able to be reduced to a gap width below the initial gap width with the aid of a displacement of the valve body in the braking direction.

17. The brake booster as recited in claim 10, wherein the brake booster is an electromechanical brake booster.

18. A braking system for a vehicle, comprising:
a brake booster including a valve body to which a booster force is transmittable in such a way that the valve body is displaceable in a braking direction, a reaction disk against which the valve body, displaced in the braking direction, presses, and an output rod situated on the reaction disk in such a way that the booster force is at least partially transmittable to the output rod via the reaction disk in such a way that the output rod is displaceable in the braking direction, wherein the brake booster is configured to be situated directly or indirectly on a master brake cylinder of the braking system in such a way that, with the aid of the output rod displaced in the braking direction, at least one displaceable piston of the master brake cylinder is at least partially displaceable into at least one assigned pressure chamber of the master brake cylinder and a counter force, counteracting an inward displacement of the at least one piston into the at least one pressure chamber, being exertable on the output rod, whereby the output rod is pressable counter to the braking direction, and wherein at least one of the valve body and the output rod is formed in such a way that a relative movement of the output rod aligned counter to the braking direction with respect to the valve body is limited by an impact of at least one first contact surface of the output rod on at least one second contact surface of the valve body; and
the master brake cylinder, on which the brake booster is directly or indirectly situated.
